(19) United States
(12) Patent Application Publication
(10) Pub. No.: US 2012/0095818 A1
(43) Pub. Date: Apr. 19, 2012

(54) BUSINESS CARD DIRECTORY SYSTEM AND METHOD OF USE

(76) Inventor: Brendon John Miskell, Sydney (AU)

(21) Appl. No.: 13/181,480

(22) Filed: Jul. 12, 2011

(30) Foreign Application Priority Data
Oct. 19, 2010 (AU) 2010904661

(51) Int. Cl. G06Q 30/00; G06Q 99/00

(52) U.S. Cl. 705/14.16; 705/319

(57) ABSTRACT

A business card directory system to provide a member access to an online business network that includes a server computing device that includes a member interface module and a database and an input device that is coupleable to the server computer device. The system also includes a processor system with a member interface module that is adaptive to receive the first data indicative of one or more paper based business cards and a computer program product stored on a computer usable medium that operates in combination with the processor system and a user interface module adapted to receive the first data and to present the web user interface. There is also a pair of methods for providing a business card directory.

This application claims priority to Australian Provisional Application 2010904661 filed on 19 Oct. 2010, the entire disclosure of which is incorporated by reference.

### FIELD OF THE INVENTION

The present invention relates to directories and in particular to business directories. The invention has been developed primarily for use as an online business card directory system and method and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of common general knowledge in the field. Physical paper based business cards are typically stored in a card holder, which is usually located on an owner's desk. Details associated with business cards are typically maintained in personal organizers, spreadsheets or the like.

### OBJECT OF THE INVENTION

It is an object of the present invention to overcome or ameliorate at least one of the disadvantages of the prior art, or to provide a useful alternative.

It is an object of the invention in its preferred form to provide an online business card directory system or method.

### SUMMARY OF THE INVENTION

According to an aspect of the invention there is provided a business card directory system for providing member access to an online business network, the system comprising a server computing device including a member interface module and a database, wherein a server computing device is adapted to receive first data indicative of a paper based business card. Preferably, the server computing device includes a user interface module adapted to receive the first data.

According to an aspect of the invention there is provided a business card directory system for providing member access to an online business network, the system comprising a server computing device including a member interface module and a database, wherein a server computing device is adapted to provide a user interface module for viewing one or more eCards.

Preferably, an input device is coupleable to the server computing device. More preferably, the input device can be presented as a paper based business card, from which first data indicative of the member paper based business card is generated. Most preferably, the first data is submitted to the server device via a data network.

Preferably, the server computing device includes a user interface module for presenting a web user interface.

Preferably, the server device is adapted to generate a member eCard from data indicative of a member paper based business card, which can be stored in the database. More preferably, the member eCard can be made available online to efficiently match the member to searched business services.

Preferably, the server device is adapted to generate an eCard from data indicative of a paper based business card, which can be stored in the database. More preferably, the eCard can be provided restricted availability online to a member associated with presenting the corresponding paper based business card. Most preferably, one or more eCards generated by a member, each associated with a respective third party business eCard, are privately accessible to the respective member. The one or more third party eCards are maintained in a virtual eCard folder.

Preferably, data associated with an eCard folder including one or more associated eCards can be downloaded from the server computing device and stored on a mobile interface device. More preferably, offline access to an eCard folder can be provided by the mobile interface device.

According to an aspect of the invention there is provided a method of providing a business card directory, the method comprising the steps of:
(a) accessing an online registration page;
(b) registering a first member, generating a corresponding member record, storing the member record to a database;
(c) receiving data indicative of a first member business card, generating a corresponding eCard record associated with the first member record, storing the eCard record to the database; and
(d) receiving business attributes associated with the first member, updating the first member record, storing the member record to a database.

According to an aspect of the invention there is provided a method of providing a business card directory, the method comprising the steps of:
(a) presenting a user interface accessible by a first member, and authenticating the first member; and
(b) presenting a member interface.

According to an aspect of the invention there is provided a processor system for providing a business card directory, the system comprising a member interface module and a database, wherein the system is adapted to receive first data indicative of one or more paper based business cards and present a user interface for accessing a business card directory.

According to an aspect of the invention there is provided a user access interface for a processor system, the processor system being adapted to provide a business card directory, the processor system being coupleable to a database having member records including data indicative of one or more business cards, the interface comprising a control program adapted to present a user interface for accessing the database and presenting a business card directory.

According to an aspect of the invention there is provided a method of providing a business card directory in a computer system, the method comprising the steps as herein described.

According to a further aspect of the invention there is provided a computer program product stored on a computer usable medium, the computer program product adapted to provide a method of providing a business card directory as herein described.

According to a further aspect of the invention there is provided a computer readable medium for operation with a processor device, the computer readable medium comprising computer code for executing a method comprising the steps of a method of providing a business card directory as herein described.

According to a further aspect of the invention there is provided a computer program product stored on a computer usable medium, the computer program product adapted to provide a user access interface for a computer device, the computer device being adapted to receive first data indicative of one or more paper based business card, the computer device being coupleable to database having one or more member records each associated with the first data, the computer program product comprising computer readable program means for providing a business card directory as herein described.

### BRIEF DESCRIPTION OF THE DRAWINGS

A preferred embodiment of the invention will now be described, by way of example only, with reference to the accompanying drawings in which:

FIG. 1A is a schematic view of an embodiment business card directory system according to the invention.

FIG. 1B is a schematic view of the business card directory system of FIG. 1A, showing example input devices.

FIG. 2A is a schematic view of an embodiment business card directory system according to the invention.

FIG. 2B is a schematic view of the business card directory system of FIG. 2A, showing example interface devices.

FIG. 3 is a flowchart of an embodiment business card directory method according to the invention.

FIG. 4 is a flowchart of an embodiment business card directory method according to the invention.

FIG. 5 is a schematic view of an embodiment user interface according to the invention associated with business card directory system.

FIG. 6 is a schematic view of an embodiment distributed business card directory system according to the invention.

### PREFERRED EMBODIMENT OF THE INVENTION

In an embodiment, an online business card directory system provides member's access to an online business network that includes business attributes obtained from paper based business cards. The online network can utilize the internet (typically via a web enabled user interface) and a personal mobile communication service (typically via a mobile phone, smart phone, portable digital assistant, or the like).

In an embodiment, an online service can be provided via a member user interface presented by an electronic system (for example a mobile phone), whereby a member (or subscriber) to the service can submit data indicative of a paper based business card. The service can then generate a corresponding eCard, which can be stored in a database.

This eCard can be made available online to efficiently match the member to business services and/or provide business connections associated with other members. A member eCard can be swapped with, and stored by, other members. This provides a business matching and business networking tool utilizing a paper based business card. It would be appreciated that the online business card directory can provide a business to business network. A business can include any sole trader, company, organization, association, department, club, team or group of people. The business card directory interface or method can be included in a social networking interface.

As the eCard can originate from a paper based business card, the converted eCard (online business card) can enable online matching of businesses and business services.

This further enables creation of a networked business environment. The method and system thereby enables both Business to Business (B2B) and Business to Consumer (B2C) directories and matching, which can be applied to both B2B and B2C networks. The eCard can be used as an electronic matching tool within a network environment. Data parameters associated with the business eCard being searchable, whereby members or businesses can be matched by the system. The eCard is also made available online.

An electronic business eCard can be produced, from a paper business card or the like, by obtaining attributes from the paper based business card and associating respective data parameters, wherein a member is enabled to search or match eCards using a member selected search criteria within a networked business environment.

A member to the service is enabled to generate first data indicative of the member paper based business card, for example by scanning or photographing the business card. By way of example, a mobile phone application can facilitate capturing first image data indicative of the member paper based business card and submitting this image data to an eCard Server for storing in a database. Alternatively, a business card scanning device can be used to generate first image data indicative of the member paper based business card and to submit (with or without use of an externally coupled processor device) this image data to an eCard Server for storing in a database. A member eCard can be made available online to authorized business and/or community members. Attributes associated with the eCard can be obtained from image data indicative of the paper based business card or added by the corresponding member via a member interface.

Data indicative of a business card can be provided as first image data prepared electronically. For example, a business owner or business card printer can provide electronic image data being a proof image of a business card—for generating first data indicative of a business card. Alternatively, a server computing device can enable a member to generate a business card proof image online, this proof image can be used to generating first data indicative of a business card, and may be forwarded to a business card printer for preparing a corresponding paper based business card. A business matching process enables members, both business and/or community (or non-business owners) members (or clients), to search for business services within an online business network identified by eCard attributes obtained from original paper based business card.

It will be appreciated that an advantage offered to members over a traditional business network is that a member eCard can be swapped, exchanged or stored (for example via electronic eCard folder). Based on member eCard data and related attributes, the member can be matched with other online members seeking a desired business type or business profile. The eCard can include a digital representation of the physical business card. By including business card image data, an eCard attribute can include business logos and marks presented on the paper based business card, which presents advantages over a text based business profiling system or method.

A first member, who joins the business network, can provide their physical business card, which is scanned or digitally photographed to provide an image data. The image data is converted into a digital record or eCard and stored in a database. The eCard is associated with the member record. The eCard can be used to “connect with” another existing member, storing or associating the existing member eCard with the first member record. Business connections can be made based on member assigned regions (local, country, global), which can be specified by the level of membership.

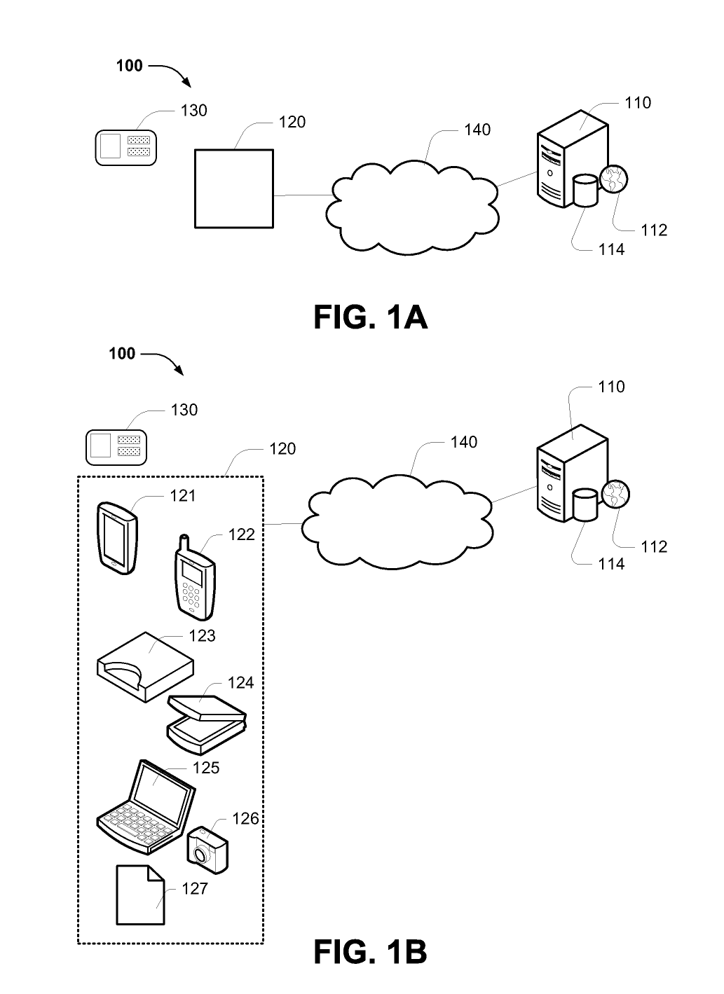

FIG. 1A shows an embodiment of an online business card directory system 100 for providing member access to an online business network. This system includes a server computing device 110 comprising a member interface module 112 and a database 114.

In this embodiment, an input device 120 can be presented a paper based business card 130, from which first data indicative of the member paper based business card can be generated. This first data can be submitted via a data network 140 to the server device 110 via a member interface module 112. The server device generates a member eCard, which can be stored in a database 114. This eCard can be made available online to efficiently match the member to business services and business connections associated with other members. The business card directory system includes a private access storage memory and a public storage memory that allows members to separately store and prioritize said first data.

A member can submit a plurality of third party business cards, each of which can s be converted into a third party eCard, retained in the database, and made accessible to this respective member. A third party card can be viewed by the respective member and used to contact the associated third party business. The member may use attributes associated with an eCard to initiate an invitation to the third party business to become another member of the business network. Typically, eCards provided by a member as a third party business remain privately accessible to the respective member, typically maintained in an eCard folder.

FIG. 1B shows an embodiment of an online business card directory system 100 for providing member access to an online business network that includes an input device 120 that can include any one or more of the following:
a smart phone 121 (typically with inbuilt camera); a mobile or cell phone 122 (typically with inbuilt camera); a business card scanner 123; a paper or photo card scanner 124;
a laptop or computer 125; a digital camera 126; or a previously generated electronic image (or file) indicative of the business card. A software application can be provided for facilitating (or automating) generation of first data (typically image data) and submitting this data to a server device.

It will be appreciated that a paper based business card can be forwarded to a third party service facility having an input device 120 for enabling the business card to be submitted. The business card and any data associated with the business card can be scanned into the server computer device to be swapped, exchanged and stored as desired by a user.

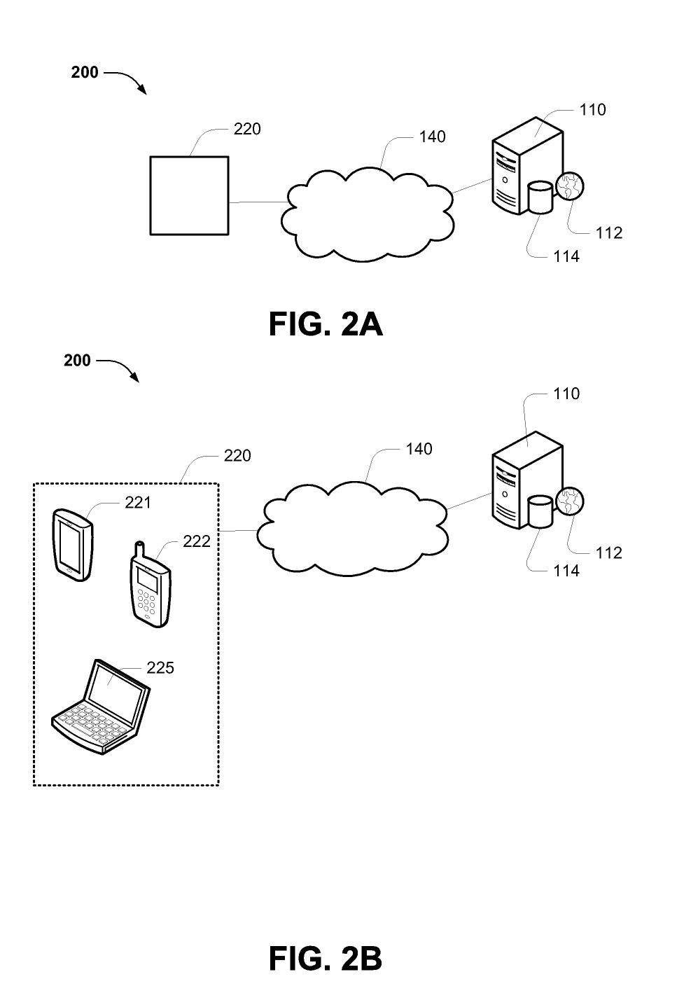

FIG. 2A shows an embodiment of an online business card directory system 100 for providing member access to an online business network. This system includes a server computing device 110 comprising a member interface module 112 and a database 114.

In this embodiment, an interface device 220 is coupled to the server computing device 110 by a data network 140. A member can view member private eCards, and eCards submitted by other members (typically made publically available). Online access to an eCard folder having one or more associated eCards can be provided by the server module.

A member (or user) interface is typically in the form of a web interface presented by the server computing device 110. A web interface can be tailored for mobile or handheld devices, for example using style sheets. Alternatively, a member interface can be a custom interface presented by interface device 220 coupleable to a database.

It will be appreciated that software applications can be provided for presenting (or displaying) a user interface, whereby the applications can make requests to the server computing device 110 via a user interface module 112 or alternatively directly access the database 114. The member can be authenticated prior to accessing a member interface.

FIG. 2B shows an embodiment of an online business card directory system 100 for providing member access to an online business network that includes an interface device 120 that can include any one or more of the following: a smart phone 221; a mobile or cell phone 222; and/or laptop or computer 125. A software application can be provided for presenting (or displaying) a member interface.

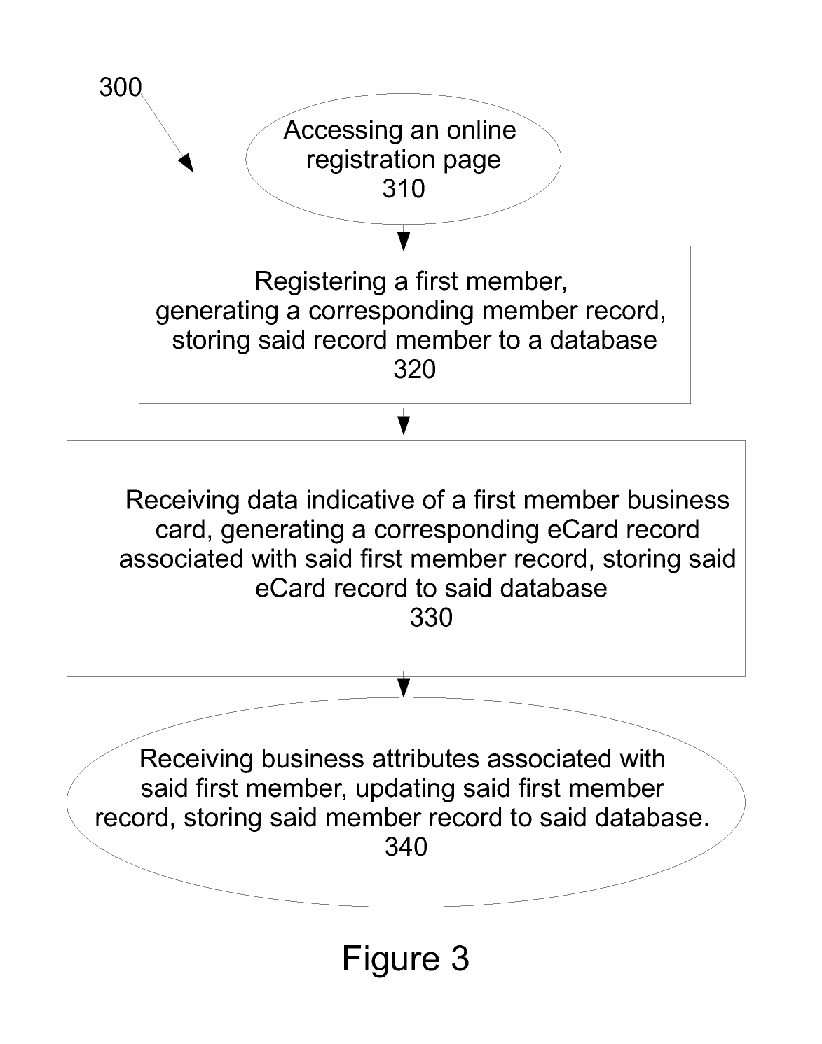

In using the system shown in FIG. 1A through FIG. 2B, a member can access an online member interface. FIG. 3 shows an embodiment method 300 of providing a business card directory, the method comprising the steps of:

STEP 310: a first person accesses an online registration page (typically after being invited by an existing member);

STEP 320: the first person registers (typically either as a full member or a trial member) becoming a first member and a corresponding member record is generated by a server module and stored to a database;

STEP 330: the first member is requested to provide data indicative of the first member business card, wherein the server module generates an eCard record associated with the member record that is stored to the database; and

STEP 340: business attributes are added to, or associated with, the member record and stored to the database. Business attributes associated with the member record can address any one or more of the following:
business or service classification type
business expertise
key words indicative of the business
benefits to customers
business types of interest
business services required (for example, in the next six months)
geographical location (for example—region, suburb, post code)
associated name (for example—business name, business owner's name, employee name)

It would be appreciated if these attributes can assist with matching appropriate business functions. This can be used in presenting search results, or when presenting targeting advertising. This can be used in developing a business network of related or associated businesses or business types.

In an embodiment business attributes associated with the member record can include a search record (or searchable record) specifying, by way of example only, business name, owner name, employee name, associated industry category, business type, geographic location, postcode and/or state. This search record can be compared against search parameters provided by another member searching the business directory. If the search results in a match for a member search record, the eCard can be displayed (typically as an electronic image of the physical business card).

It will be appreciated that registered members provide data indicative of the business and physical business cards, which can be compared when conducting a member search. The eCard can be collected and/or swapped by or between members. Collated eCards can be associated with a member record as a virtual eCard folder.

In an embodiment, data associated with an eCard folder having one or more associated eCards can be downloaded and stored on a mobile interface device. This can enable offline access to an eCard folder.

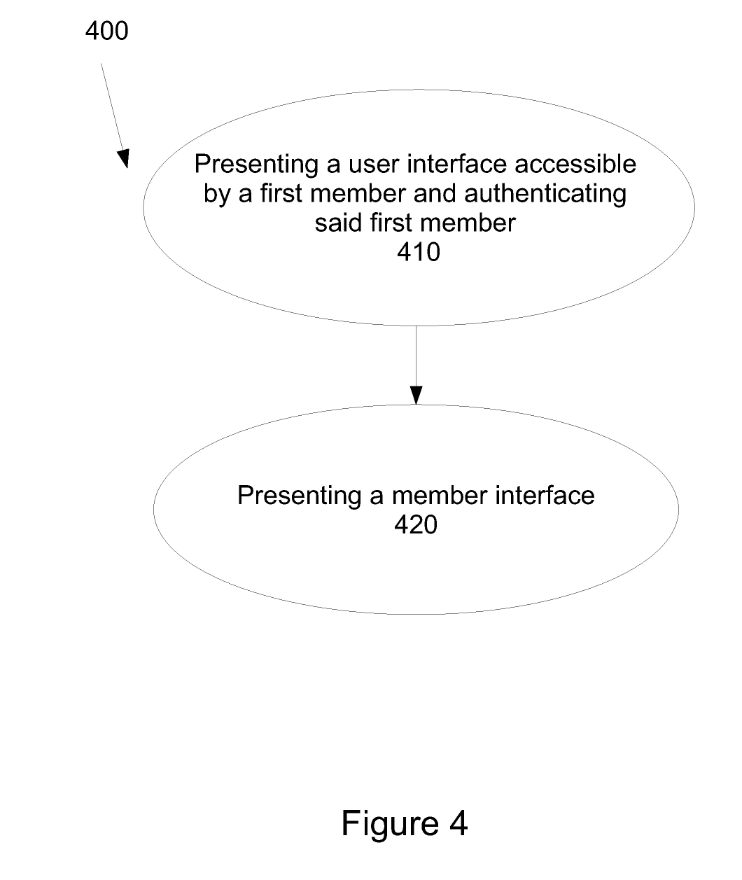

FIG. 4 shows an embodiment method 400 of providing a business card directory, the method comprising the steps of:

STEP 410: presenting a user interface accessible by a first member, authenticating the first member;

STEP 420: presenting a member interface (typically a web based interface).

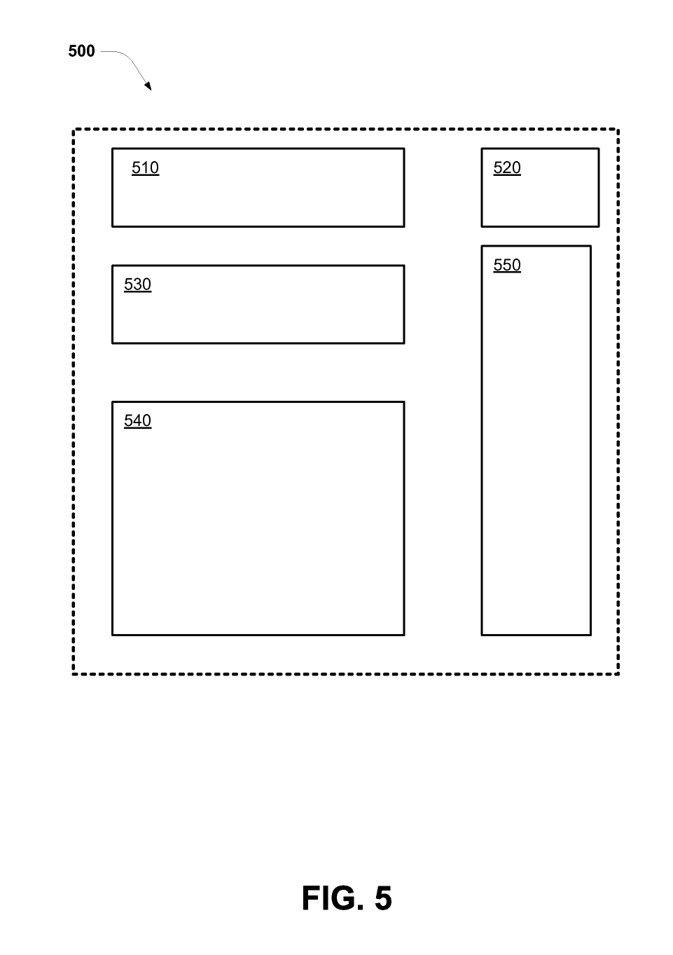

Referring to FIG. 5, an example member (or user) interface 500 can comprise any one or more of the following:
member details 510;
a business logo 520;
a business search interface 530;
an eCard folder representing associated businesses of interest 540; and
one or more eCards representing businesses of interest 550 (typically resulting from a search query or identified from preferences recorded in a member profile);

It would be appreciated that a member can market to personal business contacts, typically maintained in an eCard folder, utilizing permission based communication (typically for marketing or introducing new members). A member can represent either a consumer or a business, thereby enabling permission marketing (or communication) for Business to Business (B2B) contacts or Community to Business (C2B) contacts. This can provide access to introduce new business members, wherein only businesses who register are made publically available (searchable).

Businesses of interest are typically collated based on any one or more of:
previous searches of publically accessible member profiles; or
previous searches of a private eCard folder;
corresponding to a member profiled interest; or
corresponding to selected member attributes.

It would be appreciated that businesses of interest may be ordered either randomly, or based on a relevance ranking, or the number of other businesses introduced by the searched business. It would be appreciated that the user interface can be customized based on a member preference.

In an embodiment, a first member can further specify preferences regarding types or classes of other members that the first member may be interested in networking with. These preferences can be maintained in a member record. This enables the server computing device to search for relevant other members, and present corresponding details or eCards for acceptance by the first member (and/or storage within a first member eCard folder). This search can be undertaken automatically, whereby results are displayed to a member (such as at login, or emailed at selected intervals).

At the server computing device can include a match module (or search module) for automatically or selectively undertaking searches of the eCard repository, whereby results are displayed to a member. It will be appreciated that an online business network can be facilitated by linking members together—typically as a outcome of a search result identifying relevant other members. Special offers may be sent to members, via mobiles and emails, based on results of an automated matching tool. For example, a community member in their registration form can be asked—What services are you in the market for over the next 3 months?—wherein the member selects a refrigerator/oven/white goods. A business member in the relevant geographical region that supplies relevant services is alerted, wherein a special offer can be sent to the community member—thereby providing a permission based marketing system, wherein an offer is sent with consent being obtained first. Multiple businesses members in the same geographical region may be auctioned an exclusive listing of a specific business listing in that business region. A pay per click style campaign can be introduced. A member can negotiate a lower membership fee in return for paying a performance based fee, such as payment each time another member click on their eCard (like an advertisement).

In an embodiment, a search can be conducted, either on an eCard folder or publicly available eCard directory, based on predetermined search parameters (typically stored in a search record).

In an embodiment, the user interface can include advertising, by way of example associated with other members. System selected advertising words and advertising banners may be further included in, or presented to, a member user interface. By incorporating a virtual business card (or eCard), upon a user conducting a search, the results can be displayed in the form of business cards. A paid member (or a premium member) can be entitled to a priority location in a search result. Alternatively, search results can be ordered according to the number of other businesses introduced by the searched business (thereby providing preference to people that are building the business network). Alternatively, search results can be ordered according to an established relevance ranking. Alternatively, it is possible to randomly sort search results such that there is no perceived preference.

By way of example, a search of relevant businesses by a member can be undertaken, whereby results are presented as business card type representations. A search is typically conducted based on geographic location (postcode), business type, keywords, member name and business name.

By way of example, a server computing device can track identities of prospective leads/searching members. It is enabled, as all users/members are typically registered, to identity of the user that reviewed an online member eCard (or online business profile). A first member can have access to identities of other members who access or view the first member eCard. A first member can also be provided with a report (such as a daily, monthly, quarterly or annual report) for enabling the first member to follow-up leads. This can assist in establishing an estimate for a cost per lead. Typically, the first member can access this lead info via a private login area—or via a physical report if paying for an offline marketing services.

Once a search result is displayed in the form of one or more business eCards, a user can select, and save, an eCard to their eCard folder. Typically, a member initiates a search by providing one or more search properties, the server computing device then presents result eCards that match the search parameters, and the member can then select one or more of the result eCards to be added to the member eCard folder. It would also be appreciated that while undertaking a search, relevant eCards of interest can also be displayed, for example, as advertising. The relevance of other businesses can be assessed based on a user's previous searches, or predefined preferences. By selecting an eCard, it can also be possible to launch an associated web-page or initiate an email editor for communicating with the respective business organization.

By including an imaged based eCard, it is possible to present an ad like image for a relevant business, without requiring substantial additional effort from the business. In an embodiment, a referral reward program can be incorporated, wherein the first member that introduces a new business that becomes a member can be rewarded through a reward contribution, typically in the form of one or more reward points. Privately provided business details (for example business cards) presented to the directory and stored in association with a member profile can be considered a first introduction, whereby the member receives points if the corresponding business later becomes a member.

By way of example, reward points can be equated to a dollar amount or a physical equivalent, whereby a member can transact with another member using points. Similarly in an international implementation an exchange rate can be established between different regions. A business or community member can also get reward points for referring subsequent business or community members.

By way of example, reward points can be continually awarded to a first member for referring another member, for example as percentage of the membership fee (or equivalent points) while both members maintain a paid membership.

In an embodiment an online discount voucher can also be presented by members to other business members or consumer members. It would be appreciated that products can be purchased using points or a currency transaction. Typically, the discount voucher can be printed and used by a consumer at the corresponding business. The discount vouchers can also be presented to a member based on preferences identified in their corresponding member profile.

It will be appreciated that, accumulated reward points can be recycled back to the services or goods offered by registered members, or the online business community. Reward points can be redeemed as a complete or partial payment for goods or services.

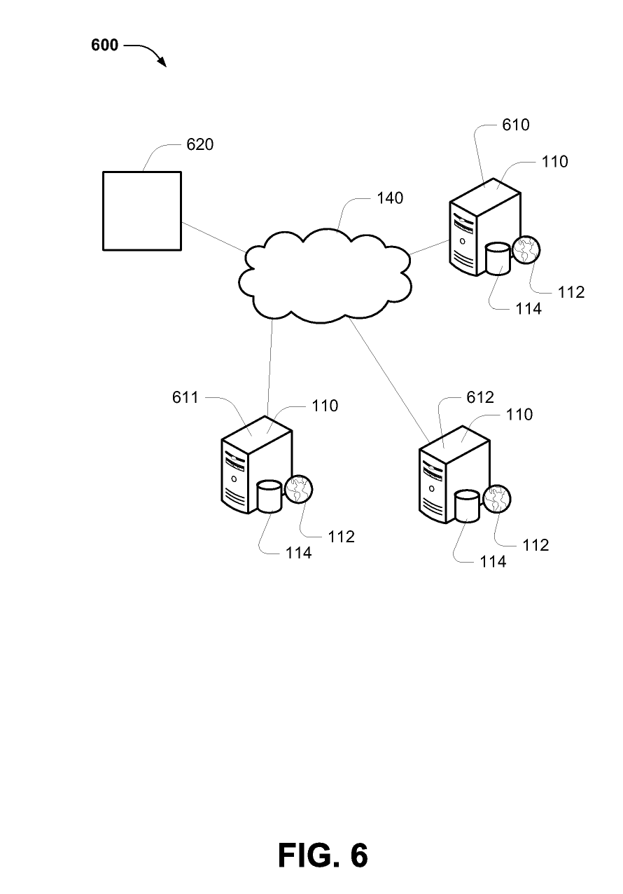

FIG. 6 shows an embodiment online business card directory system 600 for providing member access to an online business network that can include one or more server computing devices 110, each comprising a member interface module 112 and a database 114. The one or more server computing devices 110 (indicated as 610, 611 and 612) can be distributed geographically, providing a plurality of distinct online business card directories. These distinct online business card directories can be coupled via a data network 140 for communicating eCards enabling selective member's access between directories.

In this embodiment, an interface device 620 is coupled to one or more server computing devices by a data network 140. A member can view member private eCards, and eCards submitted by other members (typically made publically available). Online access to an eCard folder having one or more associated eCards can be provided by the server module. Access to one or more of a plurality of distinct online business card directories can be enabled on the basis of a membership level associated with respective member records. For example, a global level member may be entitled to access any online business card directory, while a regional member may be restricted to accessing online business card directories within a predetermined range. This can enable local, regional and global business networks to be established. A member can be identified as any of one or more member types, including: member, business member and consumer member (Community Member). Typically all members are registered members.

It would be appreciated that the paper based business card is still a primary business introduction tool. However, there are limitations in the method of distribution, requiring physical communication of the card—typically by, or on behalf of, a business owner. These paper based business cards can be lost, or discarded. These paper based business cards are typically stored in a business card holder, which is only accessible to the possessor of the cards. These limitations can be substantially reduced by providing an eCard which is stored in an online business network business directory system.

Typically, an eCard folder can be accessed either online or offline. The eCard folder can be downloaded to a portable device for offline access. An eCard can be stored in an eCard folder, thereby creating a mini directory (or sub-directory). An eCard stored in an eCard folder can also be given a ranking based on a member defined ranking.

It would be further appreciated that, by using the paper based business card as a primary basis for obtaining member (or contact) details, a member need provide less information data when recording their business details or contact details. These data can then be exchanged electronically, thereby providing greater access to networking opportunities.

Members (or users) can belong to at least three classes, including: a trial member, a registered member, or a community member. By way of example, a trial member or registered member is typically a business owner or representative, and a community member is typically a consumer or prospective business client. A community member may or may not have an associated business card, but can establish an eCard folder for collating other members of interest. It would be appreciated that the community member can receive communication from elected registered members in regards to, for example, specials or sales. Two members can swap respective eCards, or receive the other's eCard, for storage in a private eCard folder.

A member can, by way of example, include details associated with a third party business (in the form of one or more third party eCards) to their eCard folder, in a similar method provided for including their own business card. In this way, the member can maintain an eCard folder of business contacts, even when the corresponding business is not a member. This can be further used to introduce a business to membership of the business directory. One or more reward points can be awarded for each introduced business that becomes a member. The additional eCards incorporated by a first member are typically not publicly accessible until the corresponding business registers as a member, but is accessible to the first member as a contact. An eCard folder can be personalized by rating particular cards according to a member's preference.

In one embodiment, business cards provided by a member can act as a means for communicating an introduction to a new business, whereby if the new business wishes to become a member, the already prepared eCard can be used to—at least initially—represent the new business. In an alternative embodiment, if a new business becomes a member, the server computing device can identify that the new organization was previously introduced to the system by an existing member. A member that is identified as introducing a new business (or organization) can be allocated rewards points.

It would be appreciated that a business owner or employee can be a member. A business may provide a membership for each employee, or could register a single membership accessible by all employees.

The first member can further use their collection of private business records (represented as eCards in an eCard folder) to either: present marketing material; or present an invitation to become a member. An inactive record developed by the first member can be activated as a full member. Private business records stored within an eCard folder can be: exchanged, marketed to, introduced to the directory, or prioritized. The directory can enable a collection of singular business records (or eCards) to be combined in an online personal database, which can be placed in a web based environment where the records are able to be interlinked between members. Members thereby enter a network, becoming a member subscriber with the idea of networking within a corporate business group.

It will be appreciated that the illustrated system and method provides an online business card directory.

It will be further appreciated that the business network disclosed can provide:
an online and offline eCard folder accessible by a member;
an electronic (or digital) consumer to business (C2B) network;
an electronic (or digital) business to business (B2B) network;
establishes a global business network;
a referral reward program where a member can earn one or more reward points for introducing or referring a new member; and
online discount vouchers presented by a member to one or more other members.

Unless specifically stated otherwise, as apparent from the following discussions, it is appreciated that throughout the specification discussions utilizing terms such as “processing”, “computing”, “calculating”, “determining” or the like, refer to the action and/or processes of a computer or computing system, or similar electronic computing device, that manipulate and/or transform data represented as physical, such as electronic, quantities into other data similarly represented as physical quantities. In a similar manner, the term “processor” may refer to any device or portion of a device that processes electronic data, e.g., from registers and/or memory to transform that electronic data into other electronic data that, e.g., may be stored in registers and/or memory. A “processing system”, or equivalently: “computer”, “computing machine” or a “computing platform” may include one or more processors. Thus, one example is a typical processing system that includes one or more processors.

Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., an liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit.

The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagrams only show a single processor and a single memory that carries the computer-readable code, those in the art will understand that many of the components described above are included, but not explicitly shown or described in order not to obscure the inventive aspect. For example, while only a single processor “processing system” is illustrated, the term “processing system” shall also be taken to include any collection of processors that individually or jointly execute a set (or multiple sets) of instructions to perform any one or more of the methodologies discussed herein.

Methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. A computer-readable carrier medium may form, or be included in, a computer program product. The computer readable medium comprises computer code for executing a method as herein described. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Thus, one embodiment of each of the methods described herein is in the form of a computer-readable carrier medium carrying a set of instructions, e.g., a computer program that are for execution on one or more processors, e.g., one or more processors that are part of whatever the device is. Thus, as will be appreciated by those skilled in the art, embodiments of the present invention may be embodied as a method, a system such as a special purpose system, and system such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Furthermore, some of the embodiments are described herein as a method or combination of elements of a method that can be implemented by a processor of a processing system (or computer) or by other means of carrying out the function. Thus, a processor with the necessary instructions for carrying out such a method or element of a method forms a means for carrying out the method or element of a method.

Furthermore, an element described herein of a system embodiment is an example of a means for carrying out the function performed by the element for the purpose of carrying out the invention. The software (or computer program) may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media, a medium bearing a propagated signal detectable by at least one processor of one or more processors and representing a set of instructions that when executed implement a method, a carrier wave bearing a propagated signal detectable by at least one processor of the one or more processors and representing the set of instructions a propagated signal and representing the set of instructions, and a transmission medium in a network bearing a propagated signal detectable by at least one processor of the one or more processors and representing the set of instructions.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, any claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description. Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Any one of the terms “comprising”, “comprised of” or “which comprises” is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term “coupled”, when used in the claims, should not be interpreted as being limitative to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact or that two or more elements are not in direct contact with each other but yet still co-operate or interact with each other.

As used herein, unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Although the invention has been described with reference to specific examples, it will be appreciated by those skilled in the art that the invention may be embodied in many other forms. It will be appreciated that an embodiment of the invention can consist essentially of features disclosed herein. Alternatively, an embodiment of the invention can consist of features disclosed herein. The invention illustratively disclosed herein suitably may be practiced in the absence of any element which is not specifically disclosed therein.

1. A business card directory system to provide a member access to an online business network, comprising:
a server computing device that includes a member interface module, a database and an input device that includes a client system, mobile cell phone or personal digital assistant that is in communication with said server computer device through said online business network;
a processor system with a member interface module that is adaptive to receive said first data indicative of one or more paper based business cards;
a computer program product stored on a computer usable medium that operates in combination with said processor system;
a user interface module adapted to receive said first data and to present said web user interface; and
a referral rewards program that allows said members to gain a plurality of reward points based on one or more new members joining said business card directory system.

2. The business card directory system according to claim 1, wherein said input device presents said paper business cards from which said first data is generated which is submitted to said server computing device via a data network.

3. The business card directory system according to claim 2, wherein said business card and said first data are scanned into said server computer device to be swapped, exchanged and stored as desired by a user.

4. The business card directory system according to claim 1, wherein said server computing device generates a member ecard from said data indicative of said member paper business card that is stored in said database.

5. The business card directory system according to claim 1, wherein said business card directory system includes a private access storage memory and a public storage memory that allows said members to separately store and prioritize said first data.

6. The business card directory system according to claim 4, wherein said member ecard is made available online to match said member to one or more searched business services.

7. The business card directory system according to claim 1, wherein said ecard is provided restricted availability online to said member associated with presenting said corresponding paper based business card.

8. The business card directory system according to claim 1, wherein said ecards generated by said member that is associated with a third party are privately accessible to said third party member.

9. The business card directory system according to claim 8, wherein said generated ecards are maintained in a virtual ecard folder.

10. The business card directory system according to claim 1, wherein said ecard folder has offline access to an ecard folder provided by said mobile interface device.

11. The business card directory system according to claim 1, wherein said server computer device is adapted to receive said first data indicative of said paper based business card.

12. A method for providing a business card directory, comprising:
accessing an online registration page;
registering a first member, generating a corresponding member record, storing said record member to a database;
receiving data indicative of a first member business card, generating a corresponding eCard record associated with said first member record, storing said eCard record to said database; and
receiving business attributes associated with said first member, updating said first member record, storing said member record to said database.

13. A method for providing a business card directory, comprising:
presenting a user interface accessible by a first member and authenticating said first member; and
presenting a member interface.

14. The method according to claim 13, wherein said method provides said business card directory on a computer system.

15. The method according to claim 14, wherein said method provides a computer program product stored on a computer usable medium.

16. The method according to claim 15, wherein said computer program product is adapted to provide said business card directory.

17. The method according to claim 16, wherein said computer program product stored on said computer usable medium is adapted to provide a user access interface for a computer device.

18. The method according to claim 17, wherein said computer device is adapted to receive a first data indicative of one or more paper based business cards.

19. The method according to claim 18, wherein said computer device is coupleable to a database having one or more member records associated with said first data.

20. The method according to claim 13, wherein said method includes a computer readable program to provide said business card directory.
